(19) United States
(12) Patent Application Publication
(10) Pub. No.: US 2005/0111594 A1
(43) Pub. Date: May 26, 2005

(54) Timing-error estimation in a digital modem

(76) Inventor: Alexey Varyzgin, Nizhny Novgorod (RU)

Correspondence Address: Blakely, Sokoloff, Taylor & Zafman LLP, Suite 101, 5285 S.W. Meadows Road, Lake Oswego, OR, 97035, US

(21) Appl. No.: 10/722,876

(22) Filed: Nov. 25, 2003

(51) Int. Cl. H04L 27/06

(52) U.S. Cl. 375/344

(57) ABSTRACT

A parabolic timing-error estimator (PTEE) determines a parabolic timing-error estimate, based on equalizer coefficients corresponding to a first portion of a digital signal received during a first time period, and equalizer coefficients corresponding to a second portion of the digital signal received during a second time period. The PTEE provides the parabolic timing-error estimate to a timing-correction value unit, which generates, based, at least in part, on the parabolic timing-error estimate, a timing-correction value used to correct timing error for a third portion of the digital signal received during a third time period.

### TECHNICAL FIELD

Embodiments of the invention relate to a digital modem, and more specifically to timing-error estimation in a digital modem.

### BACKGROUND

In digital communications, a transmitter generates digital signals at a rate referred to as the symbol rate. A digital-to-analog converter (DAC) in the transmitter's modem converts the digital signal into an analog signal, for transmission over a communication channel to a receiver. For example, the transmitter may be one computer transmitting digital information to another computer over a wired connection, such as a telephone wire or a cable, or via a wireless medium such as air, which carries, for example, radio signals.

At the receiver, an analog-to-digital converter (ADC) in the receiver's modem converts an incoming analog signal into a digital signal by sampling the analog signal at a rate commonly referred to as the sampling rate. Sampling generally refers to the process of measuring the amplitude of an analog signal at various points over a period of time commonly referred to as a sampling period. Ideally, the sampling rate at which an analog signal is sampled to convert it into a digital signal is the same as the symbol rate at which the digital signal was generated. If the sampling rate is the same as the symbol rate, the original digital signal can be accurately recovered by a receiver's modem.

Certain conditions may cause the sampling rate to differ from the symbol rate. For example, a difference between the clock frequencies of a transmitter and a receiver can cause the sampling rate to differ from the symbol rate. This is because the symbol rate is based on the frequency of the transmitter's internal oscillator, or clock, while the sampling rate is based on the frequency of the receiver's internal clock. Consequently, a difference in the frequencies of the internal clocks can result in a difference between the sampling rate and the symbol rate. A difference between the sampling rate and the symbol rate caused by a difference in transmitter and receiver clock frequencies is generally referred to as timing error.

FIG. 1 is an illustration of timing error. A receiver receives analog signal 101. Ideally, an ADC in the receiver's modem samples analog signal 101 at times corresponding to lines 102. However, because of timing error, the ADC samples analog signal 101 at times corresponding to lines 103. The amounts of time between lines 102 and lines 103 indicate amounts of timing error. As shown in FIG. 1, the amplitudes of the samples at lines 102 differ from the amplitudes of the samples at lines 103. This illustrates the effect timing error can have on accurate recovery of a digital signal.

A timing recovery circuit in a receiver's modem is used to reduce timing error, which means reducing the differences between lines 102 and lines 103 in FIG. 1. A conventional timing recovery circuit generates an estimate of the timing error, and the estimate is used to reduce timing error.

A conventional timing recovery circuit estimates timing error based on the output of a digital equalizer. Noise in a communication channel typically causes variations in the magnitude and phase of an analog signal during transmission. These variations cause distortion of a digital signal, referred to herein as channel distortion. Channel distortion affects, among other things, accurate recovery of the digital signal. A digital equalizer reduces channel distortion in a digital signal.

A digital equalizer is a filter that includes a plurality of equalizer coefficients corresponding to samples of a digital signal at multiples of a time T, where T is the time between samples. Using its equalizer coefficients, the digital equalizer performs any of a number of algorithms known in the art to filter the noise introduced by a communication channel out of the digital signal. The resulting digital signal is referred to herein as equalizer output.

A digital modem whose timing-error estimator that estimates timing error based solely on equalizer output is unable to determine timing error based on any other data. If such a digital modem was able to estimate timing error based on data in addition to equalizer output, the digital modem could estimate timing error in addition to that estimated based on equalizer output.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates an example of timing error.

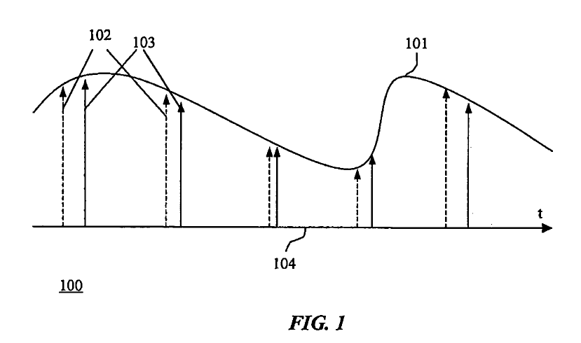

FIG. 2 is a block diagram illustrating an example of a digital communications system.

FIG. 3 is a block diagram illustrating an example embodiment of a timing recovery circuit.

FIG. 4 illustrates an example of equalizer coefficients.

FIG. 5 is a block diagram illustrating an example embodiment of a parabolic timing-error estimator.

FIG. 6 is a flow chart illustrating an example embodiment of a method of reducing timing error.

FIG. 7 is a flow chart illustrating an example embodiment of a method of generating a parabolic timing-error estimate.

FIG. 8 is a flow chart illustrating an example embodiment of a method of calculating a position of a maximum point of a parabolic function.

FIG. 9 is an example of a position of a maximum point of a parabolic function.

FIG. 10 is a block diagram illustrating an electronic system.

### DETAILED DESCRIPTION

Timing-error estimation in a digital modem is described. In the following description, for purposes of explanation, numerous specific details are set forth. It will be apparent, however, to one skilled in the art that embodiments of the invention can be practiced without these specific details. In other instances, structures and devices are shown in block diagram form in order to avoid obscuring the understanding of this description.

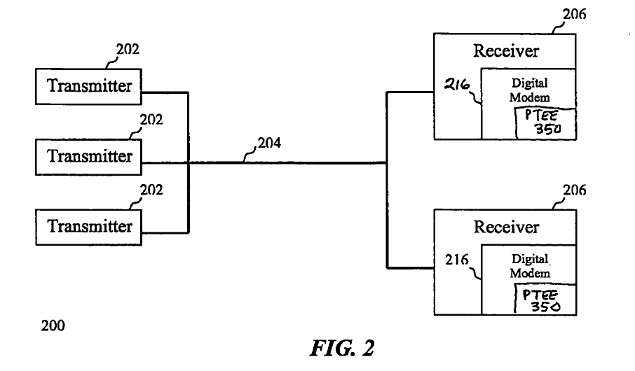

FIG. 2 is a block diagram illustrating an example of a digital communications system. Digital communications system 200 includes one or more transmitters 202, which generate a digital signal. The digital signal is converted to an analog signal for transmission to one or more receivers 206 via communication channel 204. Transmitter 202 is intended to represent a broad range of electronic systems, including, but not limited to, a server, a personal computer, a personal digital assistant (PDA), a laptop or palmtop computer, a computer system, a network access device or a television set-top box. Communication channel 204 may be any wired or wireless transmission channel, or a combination thereof, over which an analog signal is transmitted, including, but not limited to, twisted-pair wire, fiber-optic cable, coaxial cable, or air, which carries, for example, radio or satellite signals.

Receiver 206 is intended to represent a broad range of electronic systems, including, but not limited to, a personal computer, a personal digital assistant (PDA), a laptop or palmtop computer, a computer system, a network access device or a television set-top box, that include modem 216. Modem 216 is intended to represent a broad range of digital modems. Examples of digital modem 216 include, but are not limited to, a V.92 modem, a V.90 modem and a V.34 modem. See, e.g., International Telecommunication Union-Telecommunication Standardization Sector (ITU-T) Recommendation V.90, “A Digital Modem and Analogue Modem Pair for Use on the Public Switched Telephone Network (PSTN) at Data Signalling Rates of Up to 56000 Bit/s Downstream and Up to 33600 Bit/s Upstream,” September 1998; ITU-T Recommendation V.92, “Enhancements to Recommendation V.90,” November 2000, March 2002; “ITU-T Amendment 1 to Recommendation V.92—Enhancements to Recommendation V.90,” July 2001; ITU-T Recommendation V.34, “A Modem Operating at Data Signalling Rates of Up To 33600 Bit/s For Use on the General Switched Telephone Network and on Leased Point-to-Point 2-Wire Telephone-type Circuits,” February 1998.

Digital modem 216 includes parabolic timing-error estimator (PTEE) 350. As explained in more detail below, PTEE 350 enables digital modem 216 to determine timing error from a parabolic function based on equalizer coefficients, which conventional timing-error estimators cannot do. Consequently, digital modem 216 is able to estimate timing error in addition to that estimated based on equalizer output, and thus is better able to reduce timing error.

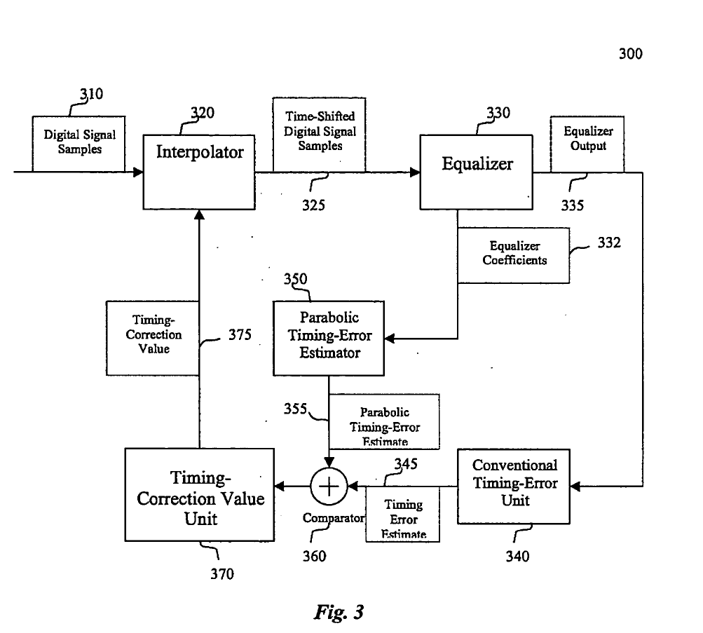

FIG. 3 is a block diagram illustrating an example embodiment of a timing recovery circuit. Timing recovery circuit (TRC) 300 includes interpolator 320. An ADC (not shown) receives an analog signal, samples the analog signal according to the ADC's sampling rate to convert the analog signal into a digital signal. The result of the sampling, digital signal samples 310, are input to interpolator 320.

Based on timing-correction value 375 (generated as explained below), interpolator 320 regenerates the samples at times that are closer to the times at which they would have occurred if the ADC's sampling rate was the same as transmitter 202's symbol rate. This reduces timing error by shifting the samples and effectively adjusting the sampling rate so that it is closer to the symbol rate, resulting in time-shifted digital signal 325. Although FIG. 3 is described in terms of an interpolator, TRC 300 may include any device known in the art that time-shifts digital signals and/or digital signal samples.

TRC 300 further includes digital equalizer 330, which receives time-shifted digital signal 325. Using equalizer coefficients 332, digital equalizer 330 performs one of many algorithms known in the art to filter out noise introduced by communication channel 204, resulting in equalizer output 335. Equalizer 330 is intended to represent any number of digital equalizers known in the art. There is no restriction or requirement regarding the number of equalizer coefficients 332 included in digital equalizer 330.

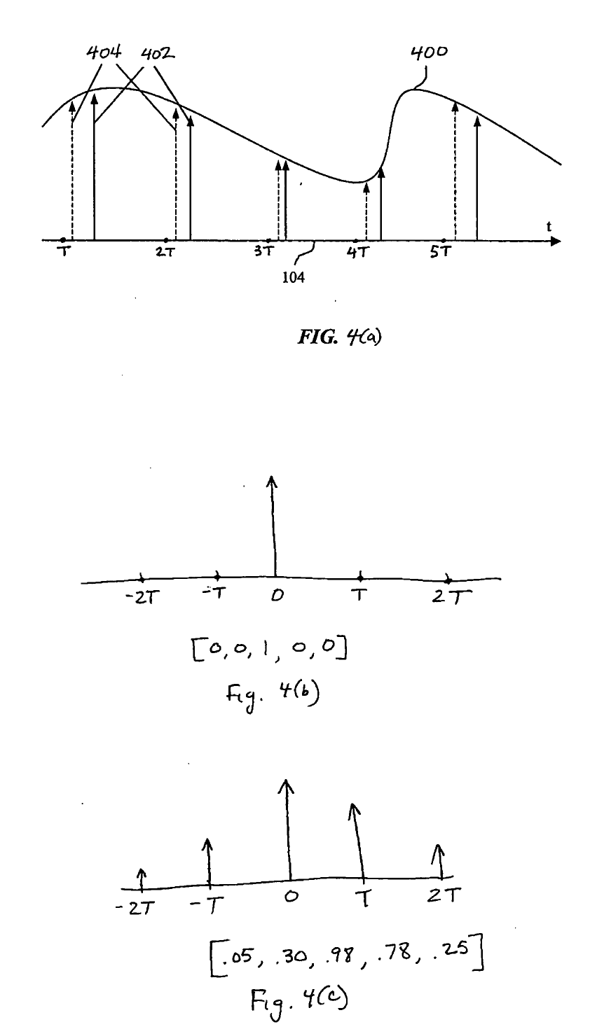

FIG. 4 illustrates an example of equalizer coefficients. FIG. 4(a) illustrates analog signal 400 sampled to generate samples 402 for a digital signal. Samples 404 illustrate the digital signal shifted by interpolator 320 so that they occur closer to sampling times T than samples 402. Samples 404 are input to digital equalizer 330.

FIG. 4(b) illustrates equalizer coefficients 332 in an ideal case, when channel distortion is not present. The equalizer coefficient corresponding to the peak of a digital signal has a value of 1, for example, while all other equalizer coefficients have a value of 0. The equalizer coefficient corresponding to the peak of the digital signal is referred to as the main equalizer coefficient.

FIG. 4(c) illustrates equalizer coefficients 332 when channel distortion is present. In that case, equalizer coefficients other than the main equalizer coefficient have a value, although the main equalizer coefficient has the largest value.

Equalizer output 335, that is, the samples for the digital signal having a corrected phase and amplitude because channel-distortion present in time-shifted digital signal 325 has been reduced, is provided to conventional timing-error unit 340. Conventional timing-error unit 340 is intended to represent any combination of components for generating timing-error estimate 345 based on equalizer output 335 and/or any combination of components for generating timing-error estimate 345 in any manner other than the technique used by PTEE 350 described below. For example, conventional timing-error unit 340 may include a slicer and a timing-error estimator, as are known in the art.

Equalizer coefficients 332 are provided to PTEE 350, which generates parabolic timing-error estimate 355, as explained in more detail below. Timing-error estimate 345 and parabolic timing-error estimate 355 are input to timing-correction value unit 370 via summator 360. Timing-correction value unit 370 may be any element known in the art that generates or otherwise determines a timing-correction value based on one or more timing-error estimates. Examples of timing-correction value unit 370 include, but are not limited to, a phase lock loop (PLL) or a delay lock loop (DLL), as are known in the art. For purposes of illustration and ease of explanation, timing-correction value unit 370 is also described herein in terms of a PLL 370. PLL 370 combines timing-error estimate 345 and parabolic timing-error estimate 355 in any manner known in the art to generate timing-correction value 375. Timing-correction value is input to interpolator 320, which uses timing-correction value 375 to reduce timing error as explained above. Summator 360 is intended to represent any number of summators known in the art. Although FIG. 3 is described in terms of a summator, TRC 300 may include any element known in the art that combines data in a digital circuit.

Although FIG. 3 has been described in terms of combining timing-error estimate 345 and parabolic timing-error estimate 355, embodiments of the invention may be practiced by estimating parabolic timing-error estimate 355 without regard to timing-error estimate 345. In that case, timing-correction value 375 is based solely on parabolic timing-error estimate 355.

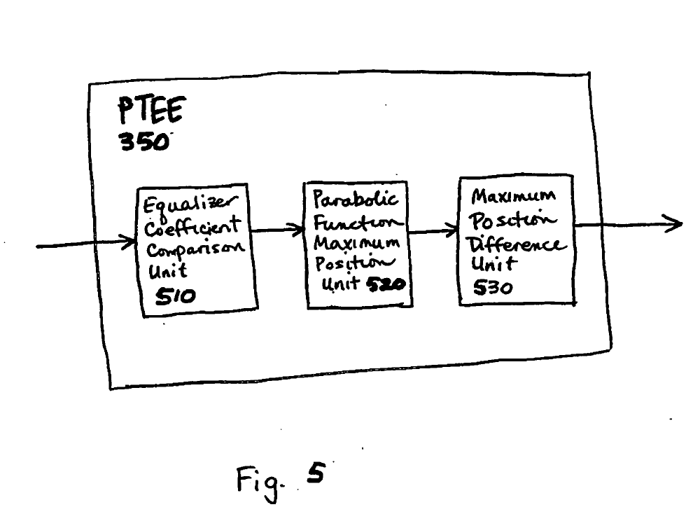

FIG. 5 is a block diagram illustrating an example embodiment of a parabolic timing-error estimator. Parabolic timing-error estimator (PTEE) 500 can be implemented in software, hardware or a combination thereof. PTEE 500 includes equalizer coefficient comparison unit (ECCU) 510, parabolic function maximum position unit (PMPU) 520, and maximum position difference unit (MPDU) 530.

As explained in more detail below, ECCU 510 receives equalizer coefficients 332, identifies the main equalizer coefficient, that is, the equalizer coefficient corresponding to the peak of a digital signal. ECCU 510 also identifies the equalizer coefficients adjacent to the main equalizer coefficient. Using the values of the identified equalizer coefficient, PMPU 520 calculates a position of a maximum point of a parabolic function that is based on the coefficient values. MPDU 530 calculates the difference between the positions of the maximum points of parabolic functions for digital signals that are adjacent in time. The difference between the positions of the maximum points constitutes parabolic timing-error estimate 355.

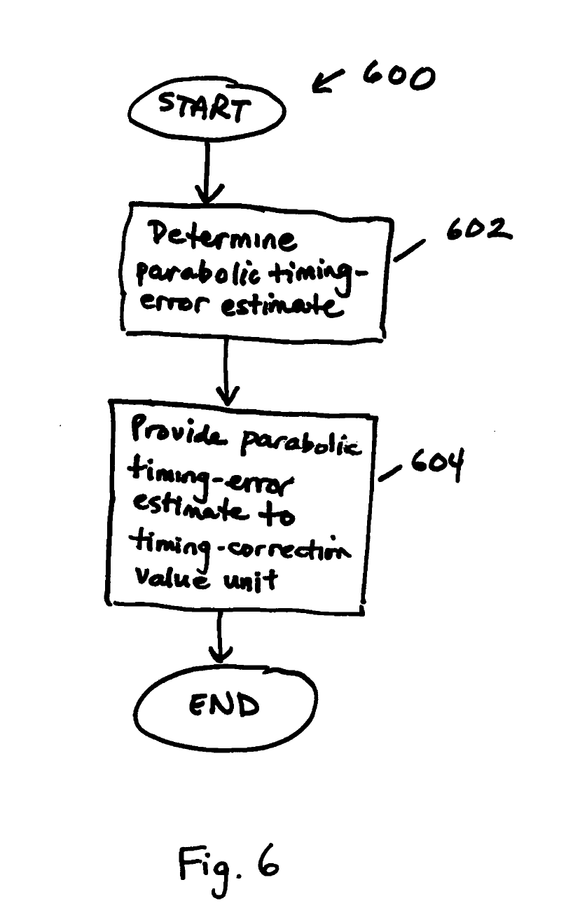

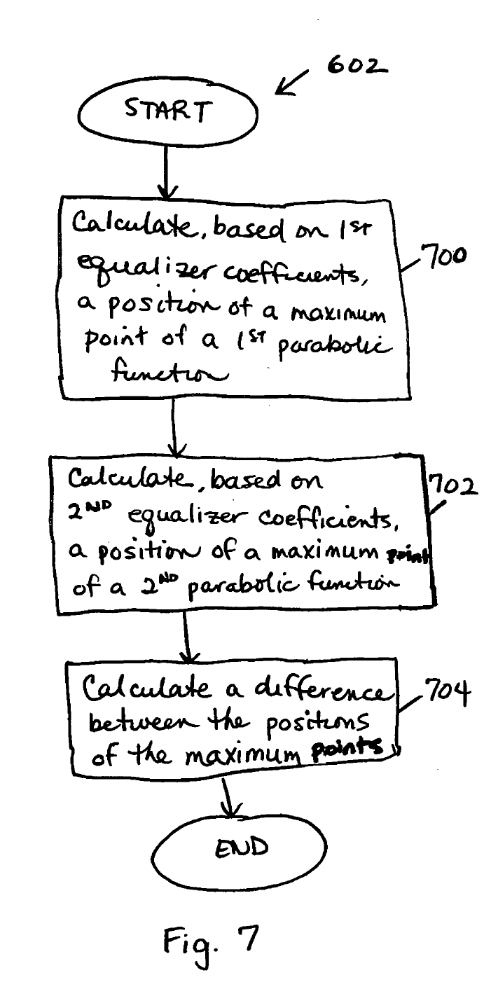

FIG. 6 is a flow chart illustrating an example embodiment of a method of reducing timing error. At 602 of method 600, PTEE 500 determines parabolic timing-error estimate 355, based on equalizer coefficients for a portion of a digital signal received at receiver 206 during a first time period and equalizer coefficients for a second portion of the digital signal received at a second time period that is adjacent to the first time period. This is described in more detail in FIG. 7.

At 604, PTEE 500 provides parabolic timing-error estimate 355 to timing-correction value unit/PLL 370, which generates timing-correction value 375 based on parabolic timing-error estimate 355. That is, PLL 370 combines parabolic timing-error estimate 355 with conventional timing-error estimate 345 to generate timing-correction value 375, or PLL 370 generates timing-correction value 375 based on only parabolic timing-error estimate 355. PLL 370 provides timing-correction value 375 to interpolator 320, which uses timing-correction value 375 to reduce timing error for a portion of the digital signal received at during a third time period that is adjacent to the second time period. An example of the time periods is a sampling period during which an ADC samples an analog signal.

FIG. 7 is a flow chart illustrating an example embodiment of a method of generating a parabolic timing-error estimate. At 700 of method 602, PTEE 500 calculates a position of a maximum point of a first parabolic function. The first parabolic function is based on the equalizer coefficients corresponding to the portion of the digital signal received during the first time period. At 702, PTEE 500 calculates a position of a maximum point of a second parabolic function. The second parabolic function is based on the equalizer coefficients corresponding to the portion of the digital signal received during the second time period. At 704, PTEE 500 calculates a difference between the maximum point of the first parabolic function and the maximum point of the second parabolic function. This difference is parabolic timing-error estimate 355.

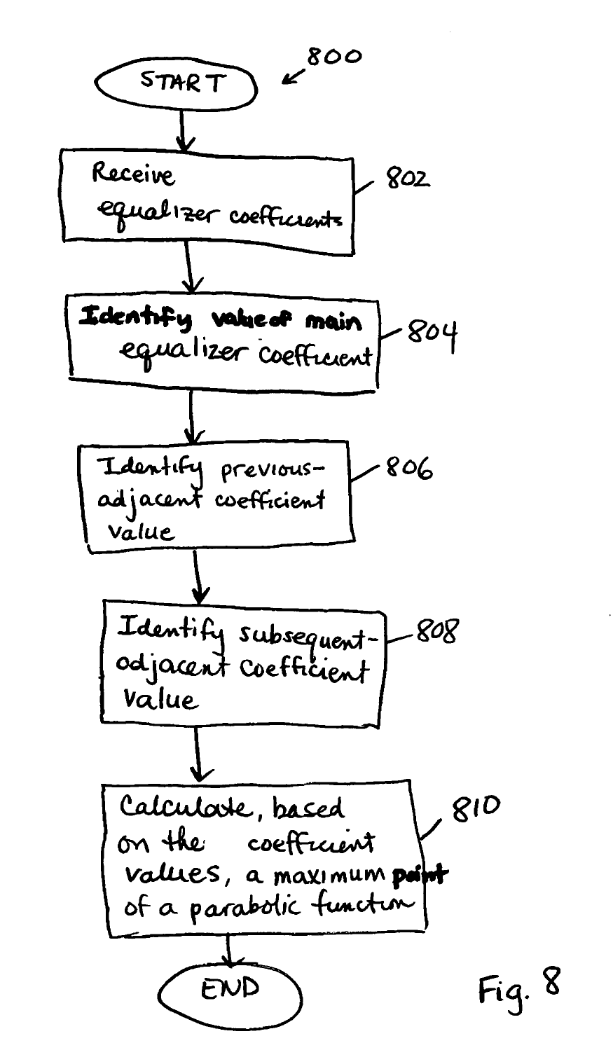

FIG. 8 is a flow chart illustrating an example embodiment of a method of calculating a position of a maximum point of a parabolic function. At 802 of method 800, ECCU 510 receives equalizer coefficients 332 from digital equalizer 330. At 804, ECCU 510 identifies the value of the main equalizer coefficient.

At 806, ECCU 510 identifies the value of the equalizer coefficient immediately preceding the main equalizer coefficient. This equalizer coefficient value is referred to herein as the previous-adjacent coefficient value. At 808, ECCU identifies the value of the equalizer coefficient immediately following the main equalizer coefficient. This equalizer coefficient value is referred to herein as the subsequent-adjacent coefficient value.

At 810, PMPU 420 calculates a position of a maximum point of a parabolic function, based on the main coefficient value, the previous-adjacent coefficient value and the subsequent-adjacent coefficient value. The position of the maximum value is calculated according to the following equation: p=d (y₋−y₊)/(y₊−2y₀+y₋)/2, where y₀ is the largest coefficient value, y₊ is the previous-adjacent coefficient value and y₋ is the subsequent-adjacent coefficient value. The value d is the receiver sampling rate. PMPU 420 determines d based on the equalizer coefficients provided for a given portion of the digital signal.

The equation for the maximum point of the parabolic function is developed as follows. It is generally well-known that using the following equation, only one parabolic function can be generated among three time-adjacent points:
y=ax²+bx+c. (1)

The following equations are used to determine the unknown values a and b:
c=y₀
ad²+bd+c=y₊
ad²−bd+c=y₋ (2)
Solving for a, b and c provides the following equations:
a=(y₊−2y₀+y−)/(2d²)
b=(y₊−y₋)/(2d)
c=y₀
The equation y′=2ax+b is the derivative of equation (1) above. In order to determine p, y′is equated to zero, and solving for x, where x=p, results in p=−b/(2a).
Substituting equations (3) for a and b into p=−b/(2a) results in p=d (y₋−y₊)/(y₊−2y₀+y₋)/2, as set forth above.

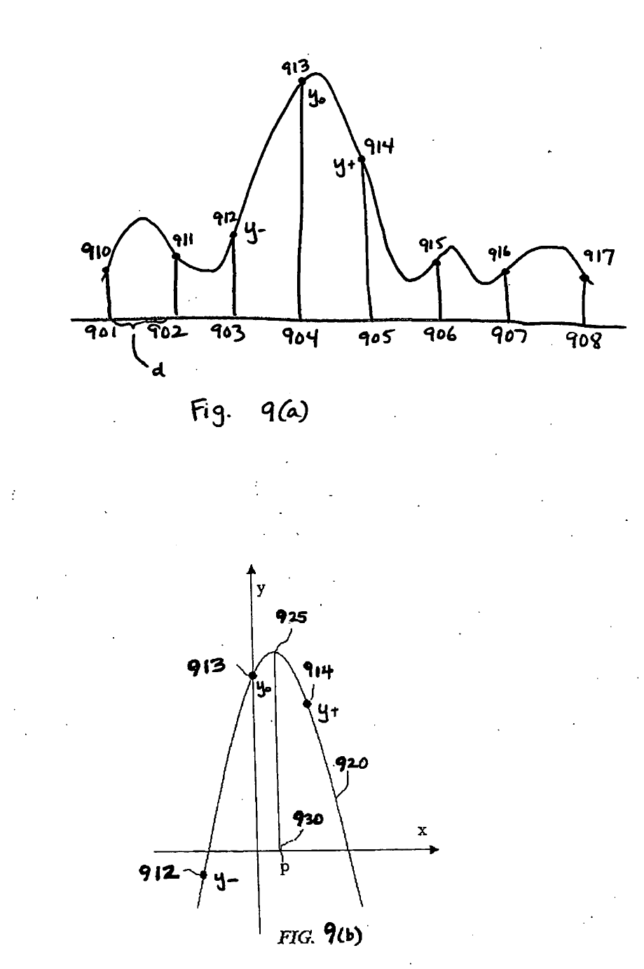

FIG. 9 illustrates an example of a position of a maximum point of a parabolic function. FIG. 9(a) shows equalizer coefficient values 910-917 corresponding to equalizer coefficients 901-908. The largest equalizer coefficient value, y₀, is indicated by point 913. Point 912 corresponds to the value y of the equalizer coefficient immediately preceding equalizer coefficient 904, while point 914 corresponds to the value y₊ of the equalizer coefficient immediately following equalizer coefficient 900. The spacing between each of equalizer coefficients 901-908 indicates the receiver sampling rate d, which corresponds to T in FIG. 4. FIG. 9(b) shows parabolic function 920 generated from values 912, 913 and 914. Point 925 corresponds to the maximum point of parabolic function 920, and point 930 is the position p of the maximum point of parabolic function 920.

FIGS. 6-8 describe example embodiments of the invention in terms of a method. However, one should also understand them to represent a machine-accessible medium having recorded, encoded or otherwise represented thereon instructions, routines, operations, control codes, or the like, that when executed by or otherwise utilized by an electronic system, cause the electronic system to perform the methods as described above or other embodiments thereof that are within the scope of this disclosure.

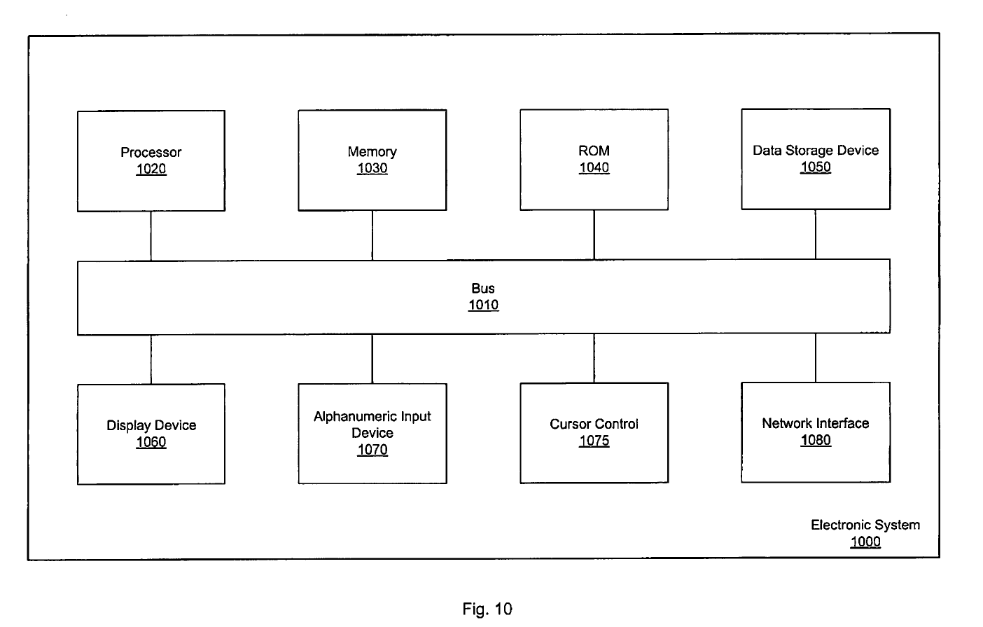

FIG. 10 is a block diagram of one embodiment of an electronic system. The electronic system is intended to represent a range of electronic systems, including, for example, a personal computer, a personal digital assistant (PDA), a laptop or palmtop computer, a cellular phone, a computer system, a network access device, etc. Other electronic systems can include more, fewer and/or different components. The methods of FIGS. 6-8 can be implemented as sequences of instructions executed by the electronic system. The sequences of instructions can be stored by the electronic system, or the instructions can be received by the electronic system (e.g., via a network connection). The electronic system can be coupled to a wired network, e.g., via a cable such as a coaxial cable or twisted-pair cable, a wireless network, e.g., via radio or satellite signals, or a combination thereof.

Electronic system 1000 includes a bus 1010 or other communication device to communicate information, and processor 1020 coupled to bus 1010 to process information. While electronic system 1000 is illustrated with a single processor, electronic system 1000 can include multiple processors and/or co-processors. Processor 1020 may be a general-purpose processor, an application specific integrated circuit (ASIC), or any other type of processor/integrated circuit.

Electronic system 1000 further includes random access memory (RAM) or other dynamic storage device 1030 (referred to as memory), coupled to bus 1010 to store information and instructions to be executed by processor 1020. Memory 1030 also can be used to store temporary variables or other intermediate information while processor 1020 is executing instructions. Electronic system 1000 also includes read-only memory (ROM) and/or other static storage device 1040 coupled to bus 1010 to store static information and instructions for processor 1020. In addition, data storage device 1050 is coupled to bus 1010 to store information and instructions. Data storage device 1050 may comprise a magnetic disk (e.g., a hard disk) or optical disc (e.g., a CD-ROM) and corresponding drive.

Electronic system 1000 may further comprise a display device 1060, such as a cathode ray tube (CRT) or liquid crystal display (LCD), to display information to a user. Alphanumeric input device 1070, including alphanumeric and other keys, is typically coupled to bus 1010 to communicate information and command selections to processor 1020. Another type of user input device is cursor control 1075, such as a mouse, a trackball, or cursor direction keys to communicate direction information and command selections to processor 1020 and to control cursor movement on flat-panel display device 1060. Electronic system 1000 further includes network interface 1080 to provide access to a network, such as a local area network or wide area network.

Instructions are provided to memory from a machine-accessible medium, or an external storage device accessible via a remote connection (e.g., over a network via network interface 1080) providing access to one or more electronically-accessible media, etc. A machine-accessible medium includes any mechanism that provides (i.e., stores and/or transmits) information in a form readable by a machine (e.g., a computer). For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the embodiments of the invention. Thus, the embodiments of the invention are not limited to any specific combination of hardware circuitry and software instructions.

Reference in the foregoing specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the embodiments of the invention. The specification and drawings are, accordingly, are to be regarded in an illustrative rather than a restrictive sense.

1. A method, comprising:
determining, based on first equalizer coefficients corresponding to a first portion of a digital signal received during a first time period, and second equalizer coefficients corresponding to a second portion of the digital signal received during a second time period, a timing-error estimate; and
providing the timing-error estimate to a timing-correction value unit, wherein the timing-correction value unit generates, based, at least in part, on the timing-error estimate, a timing-correction value used to correct timing error for a third portion of the digital signal received during a third time period.

2. The method of claim 1, wherein determining, based on the first equalizer coefficients and the second equalizer coefficients, the parabolic timing-error estimate comprises:
calculating, based on the first equalizer coefficients a position of a maximum point of a first parabolic function;
calculating, based on the second equalizer coefficients, a position of a maximum point of a second parabolic function; and
determining a difference between the maximum point of the first parabolic function and the maximum point of the second parabolic function.

3. The method of claim 2, wherein calculating, based on equalizer coefficients, a position of a maximum point of a parabolic function comprises:
receiving equalizer coefficients;
identifying a value of an equalizer coefficient having a largest value among the equalizer coefficients, wherein the equalizer coefficient having the largest value comprises a main equalizer coefficient;
identifying a previous-adjacent coefficient value corresponding to an equalizer coefficient immediately preceding the main equalizer coefficient;
identifying a subsequent-adjacent coefficient value corresponding to an equalizer coefficient immediately following the main equalizer coefficient; and
calculating, based on the main equalizer coefficient value, the previous-adjacent coefficient value and the subsequent-adjacent coefficient value, the maximum point of the parabolic function.

4. The method of claim 3, wherein calculating, based on the main equalizer coefficient value, the previous-adjacent coefficient value and the subsequent-adjacent coefficient value, the maximum point of the parabolic function comprises calculating the maximum point of the parabolic function according to the formula p=d (y₋−y₊)/(y₊−2y₀+y₋)/2, where p comprises the maximum point of the parabolic function, d comprises a time between equalizer coefficients, y₊ comprises the subsequent-adjacent equalizer coefficient value, y₋ comprises the previous-adjacent equalizer coefficient value, and y₀ comprises the main equalizer coefficient value.

5. The method of claim 1, wherein the timing-correction value unit comprises a phase lock loop.

6. An apparatus, comprising:
an equalizer coefficient comparison unit, to receive equalizer coefficients for a first portion of a digital signal and a second portion of the digital signal, determine, for the first portion and the second portion, an equalizer coefficient having a largest value among the equalizer coefficients, wherein the equalizer coefficient having the largest value comprises a main equalizer coefficient, identify a previous-adjacent coefficient value corresponding to an equalizer coefficient immediately preceding the main equalizer coefficient and identify a subsequent-adjacent coefficient value corresponding to an equalizer coefficient immediately following the main equalizer coefficient;
a parabolic function maximum position unit, to calculate, for the first portion of the digital signal and the second portion of the digital signal, a position of a maximum point of a parabolic function, based on the main coefficient value, the previous-adjacent coefficient value and the subsequent-adjacent coefficient value; and
a maximum position difference unit, to determine a difference between the maximum point of the parabolic function for the first portion of the digital signal and the maximum point of the parabolic function for the second portion of the digital signal, wherein the difference comprises a parabolic timing-error estimate.

7. The apparatus of claim 6, further comprising an equalizer, to provide the equalizer coefficients for the first portion of the digital signal and the equalizer coefficients for the second portion of the digital signal.

8. The apparatus of claim 7, wherein the equalizer comprises an adaptive equalizer.

9. The apparatus of claim 8, wherein the parabolic function maximum position unit calculates the position of the maximum value according to the equation p=d (y₋−y₊)/(y₊−2y₀+y₋)/2, where y₀ is the magnitude of the largest coefficient value, y₊ is the magnitude of the previous-adjacent coefficient value, y₋ is the magnitude of the subsequent-adjacent coefficient value, and d is a receiver sampling rate.

10. The apparatus of claim 9, further comprising a timing-correction value unit, to receive the parabolic timing-error estimate and generate a timing-correction value based, at least in part, on the parabolic timing-error value.

11. The apparatus of claim 10, further comprising an interpolator, to receive the timing-correction value from the timing-correction value unit, and time shift a third portion of the digital signal based on the timing-correction value.

12. The apparatus of claim 11, further comprising a timing-error estimator unit, to generate a timing-error estimate based on an output of the equalizer.

13. The apparatus of claim 12, further comprising a comparator, to combine the timing-error estimate with the parabolic timing-error estimate to generate the timing-correction value.

14. The apparatus of claim 10, wherein the timing-correction value unit comprises a phase lock loop.

15. An article of manufacture comprising:
a machine-accessible medium including thereon sequences of instructions that, when executed, cause an electronic system to:
determine, based on first equalizer coefficients corresponding to a first portion of a digital signal received during a first time period, and second equalizer coefficients corresponding to a second portion of the digital signal received during a second time period, a timing-error estimate; and
provide the timing-error estimate to a timing-correction value unit, wherein the timing-correction value unit generates, based, at least in part, on the timing-error estimate, a timing-correction value used to correct timing error for a third portion of the digital signal received during a third time period.

16. The article of manufacture of claim 15, wherein the sequences of instructions that, when executed, cause the electronic system to determine, based on the first equalizer coefficients and the second equalizer coefficients, the parabolic timing-error estimate comprise sequences of instructions that, when executed, cause the electronic system to:
calculate, based on the first equalizer coefficients a position of a maximum point of a first parabolic function;
calculate, based on the second equalizer coefficients, a position of a maximum point of a second parabolic function; and
determine a difference between the maximum point of the first parabolic function and the maximum point of the second parabolic function.

17. The article of manufacture of claim 16, wherein the sequences of instructions that, when executed, cause the electronic system to calculate, based on equalizer coefficients, a position of a maximum point of a parabolic function comprise sequences of instructions that, when executed, cause the electronic system to:
receive equalizer coefficients;
identify a value of an equalizer coefficient having a largest value among the equalizer coefficients, wherein the equalizer coefficient having the largest value comprises a main equalizer coefficient;
identify a previous-adjacent coefficient value corresponding to an equalizer coefficient immediately preceding the main equalizer coefficient;
identify a subsequent-adjacent coefficient value corresponding to an equalizer coefficient immediately following the main equalizer coefficient; and
calculate, based on the main equalizer coefficient value, the previous-adjacent coefficient value and the subsequent-adjacent coefficient value, the maximum point of the parabolic function.

18. The article of manufacture of claim 17, wherein the sequences of instructions that, when executed, cause the electronic system to calculate, based on the main equalizer coefficient value, the previous-adjacent coefficient value and the subsequent-adjacent coefficient value, the maximum point of the parabolic function comprise sequences of instructions that, when executed, cause the electronic system to calculate the maximum point of the parabolic function according to the formula p=d (y₋−y₊)/(y₊−2y₀+y₋)/2, where p comprises the maximum point of the parabolic function, d comprises a time between equalizer coefficients, y₊ comprises the subsequent-adjacent equalizer coefficient value, y₋ comprises the previous-adjacent equalizer coefficient value, and y₀ comprises the main equalizer coefficient value.

19. The article of manufacture of claim 15, wherein the sequences of instructions that, when executed, cause the electronic system to provide the parabolic timing-error estimate to the timing-correction value unit comprise sequences of instructions that, when executed, cause the electronic system to provide the parabolic timing-error estimate to a phase lock loop.

20. A system, comprising:
a processor;
a network interface coupled with the processor; and
an article of manufacture comprising a machine-accessible medium including thereon sequences of instructions that, when executed, cause an electronic system to:
determine, based on first equalizer coefficients corresponding to a first portion of a digital signal received during a first time period, and second equalizer coefficients corresponding to a second portion of the digital signal received during a second time period, a parabolic timing-error estimate; and
provide the parabolic timing-error estimate to a timing-correction value unit, wherein the timing-correction value unit generates, based, at least in part, on the parabolic timing-error estimate, a timing-correction value used to correct timing error for a third portion of the digital signal received during a third time period.

21. The system of claim 20, wherein the sequences of instructions that, when executed, cause the electronic system to determine, based on the first equalizer coefficients and the second equalizer coefficients, the parabolic timing-error estimate comprise sequences of instructions that, when executed, cause the electronic system to:
calculate, based on the first equalizer coefficients a position of a maximum point of a first parabolic function;
calculate, based on the second equalizer coefficients, a position of a maximum point of a second parabolic function; and
determine a difference between the maximum point of the first parabolic function and the maximum point of the second parabolic function.

22. The system of claim 21, wherein the sequences of instructions that, when executed, cause the electronic system to calculate, based on equalizer coefficients, a position of a maximum point of a parabolic function comprise sequences of instructions that, when executed, cause the electronic system to:
receive equalizer coefficients;
identify a value of an equalizer coefficient having a largest value among the equalizer coefficients, wherein the equalizer coefficient having the largest value comprises a main equalizer coefficient;
identify a previous-adjacent coefficient value corresponding to an equalizer coefficient immediately preceding the main equalizer coefficient;
identify a subsequent-adjacent coefficient value corresponding to an equalizer coefficient immediately following the main equalizer coefficient; and
calculate, based on the main equalizer coefficient value, the previous-adjacent coefficient value and the subsequent-adjacent coefficient value, the maximum point of the parabolic function.

23. The system of claim 22, wherein the sequences of instructions that, when executed, cause the electronic system to calculate, based on the main equalizer coefficient value, the previous-adjacent coefficient value and the subsequent-adjacent coefficient value, the maximum point of the parabolic function comprise sequences of instructions that, when executed, cause the electronic system to calculate the maximum point of the parabolic function according to the formula p=d (y₋−y₊)/(y₊−2y₀+y₋)/2, where p comprises the maximum point of the parabolic function, d comprises a time between equalizer coefficients, y₊ comprises the subsequent-adjacent equalizer coefficient value, y₋ comprises the previous-adjacent equalizer coefficient value, and y₀ comprises the main equalizer coefficient value.

24. The system of claim 23, wherein the sequences of instructions that, when executed, cause the electronic system to provide the parabolic timing-error estimate to the timing-correction value unit comprise sequences of instructions that, when executed, cause the electronic system to provide the parabolic timing-error estimate to a phase lock loop.
